(19) United States
(12) Patent Application Publication
(10) Pub. No.: US 2015/0276086 A1
(43) Pub. Date: Oct. 1, 2015

(54) SYSTEM AND METHOD FOR PERFORMING VALVE DIAGNOSTICS

(71) Applicant: General Electric Company, Schenectady, NY (US)

(72) Inventors: Frederick Wilson Wheeler, Niskayuna, NY (US); Justin Shriver, Newton, MA (US)

(73) Assignee: General Electric Company, Schenectady, NY (US)

(21) Appl. No.: 14/231,059

(22) Filed: Mar. 31, 2014

(51) Int. Cl. F16K 37/00; G01M 99/00

(52) U.S. Cl. CPC F16K 37/0083; G01M 99/008

(57) ABSTRACT

A method for performing diagnostics for a valve assembly includes obtaining valve assembly information including a set of data points where each data point of the set of data points includes a position of an actuator stem. The method includes classifying each data point of the set of data points as at least one of a plurality of data point types where the plurality of data point types includes a first data point type and a second data point type. The method also includes determining at least one valve assembly characteristic based on the classification of each data point of the set of data points where determining the at least one valve assembly characteristic includes measuring the position of the actuator stem at a specific point in time.

### BACKGROUND

The field of the disclosure relates generally to collecting monitored data from industrial system devices and, more particularly, to systems, methods and computer-readable media for performing diagnostics for a valve assembly.

Many known valve assembly monitoring systems collect position and actuator pressure samples while a valve assembly is offline, i.e. the valve assembly is removed from service. Friction of a valve assembly can be measured when the valve assembly is offline. An actuator stem can be directed to move through a substantial portion of an actuator stem travel distance, at any speed, and with any number of repetitions. Valve assembly motion is facilitated by varying an air pressure in a pneumatic actuator with air that is supplied by a pneumatic valve assembly positioning system. The variations of the air pressure are controlled and regular and as such, actuator pressure changes are slow, controlled, and in predetermined increments. Generally, measurements collected while a valve assembly is offline are collected with the direction of travel of the actuator stem being known.

When a valve assembly is online, the valve assembly is placed in service for directing or controlling a flow of fluids. Due to system and environmental conditions, motion of the actuator stem may be irregular, the actuator stem may not move over a substantial portion of the total available travel distance, and rapid air pressure changes can make air pressure measurement less accurate. Generally, measurements collected while a valve assembly is operating online do not include a direction of travel of the actuator stem.

### BRIEF DESCRIPTION

In one aspect, a method for performing diagnostics for a valve assembly is provided. The method includes obtaining valve assembly information including a set of data points. Each data point of the set of data points includes a position of the actuator stem. The method includes classifying each data point of the set of data points as at least one of a plurality of data point types where the plurality of data point types include a first data point type and a second data point type. The first data point type is associated with a first direction of travel of the actuator stem. The second data point type is associated with a second direction of travel of the actuator stem. The method also includes determining at least one valve assembly characteristic based on the classification of each data point of the set of data points, where in determining the at least one valve assembly characteristic includes measuring the position of the actuator stem at a specific point in time.

In another aspect, a system for determining characteristics of a valve assembly is provided. The system includes a positioner and at least one diagnostic component. The positioner is configured to receive a plurality of setpoints and to generate a signal for positioning the actuator stem for each setpoint of the plurality of setpoints. The at least one diagnostic component is configured to receive the plurality of setpoints for positioning the actuator stem. The at least one diagnostic component is also configured to obtain valve assembly information including a set of data points. Each data point of the set of data points is associated with a position of the actuator stem. Additionally, the at least one diagnostic component is configured to classify each data point of the set of data points as at least one of a plurality of data point types where the plurality of data point types include a first data point type and a second data point type. The first data point type is associated with a first direction of travel of the actuator stem. The second data point type is associated with a second direction of travel of the actuator stem. The at least one diagnostic component is further configured to determine at least one valve assembly characteristic based on the classification of each data point of the set of data points.

In a further aspect, a computer-readable storage media for performing diagnostics for a valve assembly is provided. The computer-readable storage media has computer-executable instructions embodied thereon. When executed by at least one processor, the computer-executable instructions cause the processor to obtain valve assembly information. The valve assembly information includes a set of data points where each data point of the set of data points is associated with a point in time and include the position of the actuator stem. The computer-executable instructions cause the processor to also classify each data point of the set of data points as at least one of a plurality of data point types where the plurality of data point types include a first data point type and a second data point type. The first data point type is associated with a first direction of travel of the actuator stem. The second data point type is associated with a second direction of travel of the actuator stem. Further, the computer-executable instructions cause the processor to determine at least one valve assembly characteristic based on the classification of each data point of the set of data points. Determining the at least one valve assembly characteristic includes measuring the position of the actuator stem at a specific point in time.

### DRAWINGS

These and other features, aspects, and advantages of the present disclosure will become better understood when the following detailed description is read with reference to the accompanying drawings in which like characters represent like parts throughout the drawings, wherein:

FIG. 1 is a block diagram of an exemplary computing device;

FIG. 2 is a schematic view of an exemplary valve assembly includes an exemplary actuator stem;

FIG. 3 a graphical view of a position of the actuator stem shown in FIG. 2 in relation to actuator pressure associated with the valve assembly shown in FIG. 2;

FIG. 4 is a graphical view of exemplary data points related to a position of the valve assembly shown in FIG. 2 and an actuator pressure associated with the actuator stem shown in FIG. 2;

FIG. 5 is a graphical view of the data points shown in FIG. 4 as classified according to the present disclosure;

FIG. 6 is a flow chart of an exemplary method for performing diagnostics for the valve assembly shown in FIG. 2;

FIG. 7 is a flow chart of an exemplary method for classifying a data point associated the valve assembly shown in FIG. 2; and

FIG. 8 illustrates an example configuration of a database with a computing device, along with other related computing components, that may be used herein.

Unless otherwise indicated, the drawings provided herein are meant to illustrate features of embodiments of the disclosure. These features are believed to be applicable in a wide variety of systems comprising one or more embodiments of the disclosure. As such, the drawings are not meant to include all conventional features known by those of ordinary skill in the art to be required for the practice of the embodiments disclosed herein.

### DETAILED DESCRIPTION

In the following specification and the claims, reference will be made to a number of terms, which shall be defined to have the following meanings

The singular forms “a”, “an”, and “the” include plural references unless the context clearly dictates otherwise.

“Optional” or “optionally” means that the subsequently described event or circumstance may or may not occur, and that the description includes instances where the event occurs and instances where it does not.

Approximating language, as used herein throughout the specification and claims, may be applied to modify any quantitative representation that could permissibly vary without resulting in a change in the basic function to which it is related. Accordingly, a value modified by a term or terms, such as “about,” “approximately,” and “substantially”, are not to be limited to the precise value specified. In at least some instances, the approximating language may correspond to the precision of an instrument for measuring the value. Here and throughout the specification and claims, range limitations may be combined and/or interchanged, such ranges are identified and include all the sub-ranges contained therein unless context or language indicates otherwise.

As used herein, the terms “processor” and “computer” and related terms, e.g., “processing device” and “computing device”, are not limited to just those integrated circuits referred to in the art as a computer, but broadly refers to a microcontroller, a microcomputer, a programmable logic controller (PLC), an application specific integrated circuit, and other programmable circuits, and these terms are used interchangeably herein. In the embodiments described herein, memory may include, but is not limited to, a computer-readable medium, such as a random access memory (RAM), and a computer-readable non-volatile medium, such as flash memory. Alternatively, a floppy disk, a compact disc-read only memory (CD-ROM), a magneto-optical disk (MOD), and/or a digital versatile disc (DVD) may also be used. Also, in the embodiments described herein, additional input channels may be, but are not limited to, computer peripherals associated with an operator interface such as a mouse and a keyboard. Alternatively, other computer peripherals may also be used that may include, for example, but not be limited to, a scanner. Furthermore, in the exemplary embodiment, additional output channels may include, but not be limited to, an operator interface monitor.

Further, as used herein, the terms “software” and “firmware” are interchangeable, and include any computer program stored in memory for execution by personal computers, workstations, clients and servers.

As used herein, the term “non-transitory computer-readable media” is intended to be representative of any tangible computer-based device implemented in any method or technology for short-term and long-term storage of information, such as, computer-readable instructions, data structures, program modules and sub-modules, or other data in any device. Therefore, the methods described herein may be encoded as executable instructions embodied in a tangible, non-transitory, computer readable medium, including, without limitation, a storage device and/or a memory device. Such instructions, when executed by a processor, cause the processor to perform at least a portion of the methods described herein. Moreover, as used herein, the term “non-transitory computer-readable media” includes all tangible, computer-readable media, including, without limitation, non-transitory computer storage devices, including, without limitation, volatile and nonvolatile media, and removable and non-removable media such as a firmware, physical and virtual storage, CD-ROMs, DVDs, and any other digital source such as a network or the Internet, as well as yet to be developed digital means, with the sole exception being a transitory, propagating signal.

Furthermore, as used herein, the term “real-time” refers to at least one of the time of occurrence of the associated events, the time of measurement and collection of predetermined data, the time to process the data, and the time of a system response to the events and the environment. In the embodiments described herein, these activities and events occur substantially instantaneously.

Even though a linear actuated air-to-close valve assembly is discussed in detail below, it should be understood that any valve assembly, including without limitation, rotationally actuated valve assemblies and air-to-open valve assemblies may also be used. Additionally, even though a pneumatic actuator is discussed, any other actuator from which the actuator force can be measured or determined can be used. Further, although the typical units of force are Newtons, pressure units (PSI) are used herein and are taken to be the equivalent actuator pressure applied to the actuator diaphragm to produce a force. With this understanding, valve assembly measurements in PSI are used to describe an actuator diaphragm force, the spring force, and the frictional force.

The embodiments described herein include obtaining data associated with the actuation of an actuator stem that occurs while a valve assembly is online and operating. Data points taken while the valve assembly is operating are classified according to a direction of travel of the actuator stem at the time each data point is taken. There are a variety of time frames that data points are collected. In some embodiments, 120 data points are collected every 2 to 8 seconds and data points are collected for about 5 minutes. In other embodiments, 120 data points are collected at a time and utilized to determine valve assembly characteristics. In further embodiments, data points are collected over a period of days or weeks and utilized to determine valve assembly characteristics. However, in other embodiments, various other amounts of data points are collected over various other periods of time. For instance, a data point collected when an actuator stem is traveling in an upwards direction would be classified as an up data point whereas a data point collected when the actuator stem is traveling in a downwards direction would be classified as a down data point type. By classifying the data points according to the direction of travel of the actuator stem a more accurate estimate of valve assembly diagnostics is determined. Aspects of the present disclosure provide methods, systems, and computer-readable media for determining characteristics of the valve assembly, such as friction between the actuator stem and the packing, a low spring range, and a high spring range, using a direction of travel of the actuator stem.

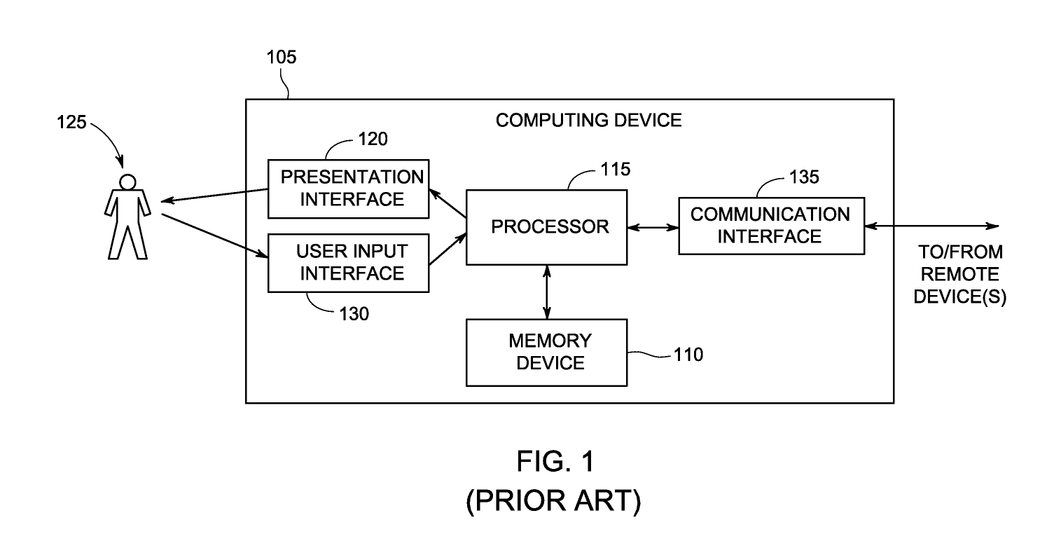

FIG. 1 is a block diagram of an exemplary computing device 105 that may be used to perform diagnostics for a valve assembly (not shown in FIG. 1). Computing device 105 monitors and/or controls any piece of equipment, any system, and any process associated with a valve assembly, such as an actuator and a positioner (not shown in FIG. 1). For example, processor 115 may be programmed by encoding an operation as one or more executable instructions and providing the executable instructions in memory device 110. In the exemplary embodiment, memory device 110 is one or more devices that enable storage and retrieval of information such as executable instructions and/or other data. Memory device 110 may include one or more computer readable media.

Memory device 110 may be configured to store operational measurements including, without limitation, real-time and historical positions of an actuator stem, directions of travel of the actuator stem, data points associated with the valve assembly, friction between the actuator stem and packing, high spring range force, low spring range force, and/or any other type data. The high spring range force refers to the force of the spring when the valve assembly is fully open. The low spring range force refers to the force of the spring when the valve assembly is fully closed. Also, memory device 110 includes, without limitation, sufficient data, algorithms, and commands to facilitate monitoring and control of the components within a valve assembly.

In some embodiments, computing device 105 includes a presentation interface 120 coupled to processor 115. Presentation interface 120 presents information, such as a user interface and/or an alarm, to a user 125. Additionally, presentation interface 120 includes one or more display devices. In some embodiments, presentation interface 120 presents an alarm associated with actuator and positioner being monitored, such as by using a human machine interface (HMI) (not shown in FIG. 1). Also, in some embodiments, computing device 105 includes a user input interface 130. In the exemplary embodiment, user input interface 130 is coupled to processor 115 and receives input from user 125.

A communication interface 135 is coupled to processor 115 and is configured to be coupled in communication with one or more other devices, such as a sensor or another computing device 105, and to perform input and output operations with respect to such devices while performing as an input channel. Communication interface 135 may receive data from and/or transmit data to one or more remote devices. For example, a communication interface 135 of one computing device 105 may transmit an alarm to the communication interface 135 of another computing device 105.

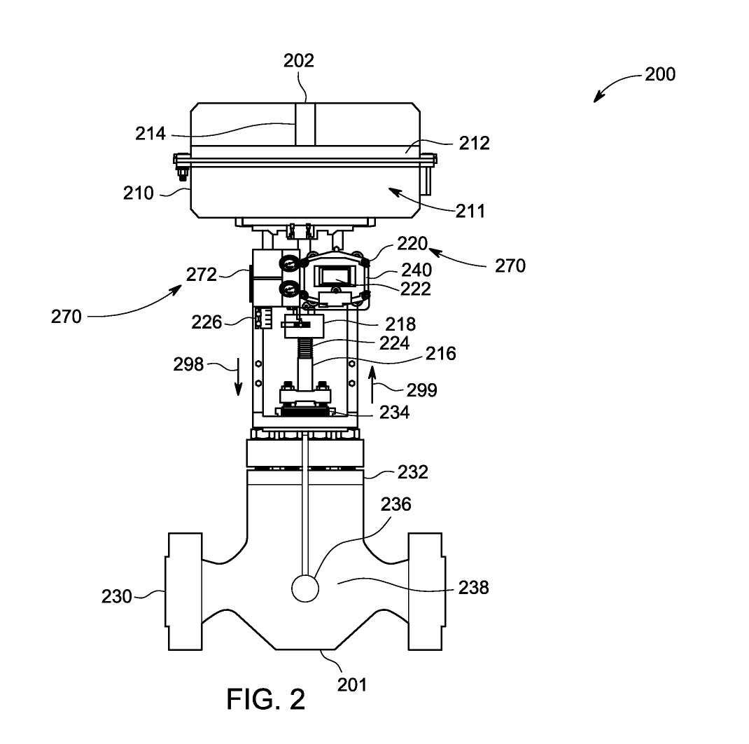

FIG. 2 is a schematic view of an exemplary valve assembly 200. Valve assembly 200 includes an actuator 210, a positioner 220, and a valve 230. Actuator 210 is configured to assist in converting energy formed by compressed air at high pressure into either linear or rotary motion. Actuator 210 includes an actuator chamber 211, diaphragm 212, a spring 214, an actuator stem 216, and a first position sensor component 218 located on actuator stem 216. Positioner 220 is configured to position actuator stem 216 to enter and exit valve 230. Positioner 220 includes a positioner display 222, computing device 240, and is in communication with a second position sensor component 226. First position sensor component 218 is coupled to actuator stem 216 such that first position sensor component 218 moves as actuator stem 216 moves. Second position sensor component 226 is fixed and coupled to a non-moving portion of valve assembly 200. In some embodiments, second position sensor component 226 is a potentiometer that is coupled to actuator stem 216 by a linkage (not shown). Valve 230 includes a valve body 232 and within valve body 232 there is a packing 234, a plug 236, and a seat 238. Computing device 240 may be similar to computing device 105 (shown in FIG. 1). Valve assembly 200 has a bottom portion 201 located proximate valve 230 and a top portion 202 located proximate actuator 210.

Additionally, in the exemplary embodiment, a system 270 includes positioner 220 coupled to a diagnostic component 272. In some embodiments, diagnostic component 272 is physically coupled to positioner 220. Alternatively, diagnostic component 272 is not physically coupled to positioner 220. However, in such alternative embodiments, diagnostic component 272 is wirelessly coupled to positioner 220. System 270 is configured to determine characteristics of valve assembly 200 as described further below. In some embodiments diagnostic component 272 is similar to computing device 105. In other embodiments, diagnostic component 272 is, without limitation, a desktop computer, a distributed control system (DCS), a PLC, a Supervisory Control and Data Acquisition (SCADA) system, and a hand-held device.

Valve assembly 200 is used to control the flow of a process fluid by varying the size of an opening. Typically, the opening is between plug 236 and seat 238, but there are other types of variable openings, such as ball valves and gate valves. Plug 236 and seat 238 are internal to valve assembly 200 and are in contact with the process fluid. Plug 236 is moved by actuator 210, which may be pneumatic, hydraulic, or electric. Actuator 210 moves plug 236 via actuator stem 216. Actuator stem 210 extends from inside valve body 232 to inside actuator 210. To prevent process fluid from leaking past actuator stem 216, but to allow actuator stem 216 to move relative to valve body 232, there is a seal, i.e. packing 234 between actuator stem 216 and valve body 232.

Packing 234 is a critical component of valve assembly 200 and a component which requires monitoring and maintenance. Packing 234 must be put in place with enough pressure against valve body 232 and actuator stem 216 such that the process fluid does not leak out of valve 230, but not with so much pressure such that the motion of actuator stem 216, which is necessary to control valve 230, is unduly impeded by high friction. A low amount of friction may indicate that packing 234 is not under enough pressure which may lead to the process fluid leaking from valve 230. A high amount of friction may lead to valve 230 not being accurately controllable due to the excess amount of frictional force. Because of the effect friction may have on the operation of actuator stem 216, system 270 facilitates measuring friction between packing 234 and actuator stem 216.

Actuator 210 defines an actuator chamber 211 in which the air pressure is adjusted and controlled. The air in actuator 210 pushes against a flexible surface, diaphragm 212, which pushes against actuator stem 216. The air pressure in actuator 212 is measured and controlled to control the position of actuator stem 216. From the air pressure in actuator 210 and diaphragm area 212, a force acting against actuator stem 216 is determined.

Spring 214 may be one or several springs. Generally, multiple springs may act collectively with the same effect as a single spring. Spring 214 pushes against diaphragm 212 in the opposite direction of the air pressure to produce an opposing force. The induced force of spring 214 is at least partially determined by the placements of spring 214 and the spring constant relating the compression of spring 214 to the force exerted. When valve 230 is fully closed the force of spring 214 is referred to as a low spring range force. When valve 230 is fully open the force of spring 214 is referred to as a high spring range force. The values of the low spring range force and the high spring range force are taken as a pair and referred to as the spring range for valve 230.

Valve assembly information collected in relation to actuator stem 216 may be used as inputs to produce estimates of valve assembly characteristics such as friction and spring range. Valve assembly information includes, but is not limited to, position data and actuator pressure data. Position data includes an indication of the position of actuator stem 216 at a specific time, direction of travel of actuator stem 216 at a specific time, and speed of actuator stem 216 at a specific time. There may be numerous ways to classify data points according to a direction of travel of actuator stem 216. Actuator pressure data includes a pressure measurement at specific time. To classify the data points, the position data is processed to determine the direction of travel of actuator stem 216. A manner of classifying the data points according to the direction of travel of actuator stem 216 is provided herein as an example. There may be other ways to classify the data points according to the direction of travel of actuator stem 216 may be used in determining characteristics of valve assembly 200.

A data point may be classified as an up data point type, a down data point type, and/or a null data point type. An up data point type is associated with actuator stem 216 traveling in an up direction 299. A down data point type is associated with actuator stem 216 traveling in a down direction 298. A null data point type is associated with actuator stem 216 changing direction from an up direction of travel to a down direction of travel or from a down direction of travel to an up direction of travel. A null data point type may also be any data point that is not classified as an up data point type or a down data point type. Further, a null data point type may be associated with an erroneous measurement, i.e. a measurement obtained as a result of an error. A null data point type is eliminated from a data sample and not used in determining of valve assembly characteristics.

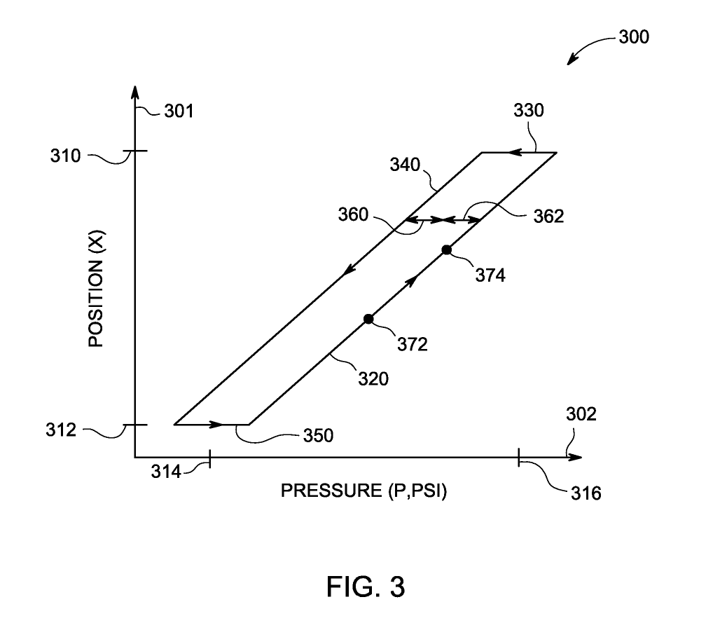

FIG. 3 illustrates a graphical view 300 of a position of actuator stem 216 (shown in FIG. 2) in relation to actuator pressure in actuator chamber 211 associated with valve assembly 200 (shown in FIG. 2). Graph 300 has a y-axis 301 and an x-axis 302. Y-axis 301 indicates a position of actuator stem 216. Along y-axis 301 are a first reference y-axis value 310 and a second reference y-axis value 312.

First reference y-axis value 310 is indicative of valve assembly 200 being fully open. Second reference y-axis value 312 is indicative of valve assembly 200 being fully closed. X-axis 302 indicates actuator pressure associated with valve assembly 200. Along x-axis 302 are a third reference x-axis value 314 and a fourth reference x-axis value 316. Third reference x-axis value 314 is indicative of a low spring range force while fourth reference x-axis value 316 is indicative of a high spring range force.

A first characteristic line 320, a second characteristic line 330, a third characteristic line 340, and a fourth characteristic line 350 each illustrate a relationship between the position of actuator stem 216 and the actuator pressure. First characteristic line 320 illustrates the relationship between the position of actuator stem 216 and the actuator pressure as actuator stem 216 travels in an upward direction. Second characteristic line 330 illustrates the relationship between the position of actuator stem 216 and the actuator pressure as actuator stem 216 changes direction from an upwards direction of travel to a downwards direction of travel. Third characteristic line 340 illustrates the relationship between the position of actuator stem 216 and the actuator pressure as actuator stem 216 travels in a downward direction. Fourth characteristic line 350 illustrates the relationship between the position of actuator stem 216 and the actuator pressure as actuator stem 216 changes direction from a downwards direction of travel to an upwards direction of travel. Additionally, a first frictional force reference line 360 and a second frictional force reference line 362 illustrates frictional force between actuator stem 216 and packing 234 at each direction of travel of actuator stem 216. As the direction of actuator stem 216 changes direction, the frictional force on actuator stem 216 changes, always opposing the direction of actuator stem 216. In each case, the frictional force is the same magnitude, but in the opposite direction. The magnitude of frictional force between actuator stem 216 and packing 234 determine a length of first friction force reference line 360, second frictional force reference line 362, and a distance between first characteristic line 320 and third characteristic line 340. First friction force reference line 360 and second frictional force reference line 362 is double the total frictional force and representative of the friction force in each direction of travel of actuator stem 216.

A method of classifying a data point as an up data point type, a down data point type, and a null data point type involves comparing two data points and the associated positions of actuator stem 216 at each data point. In reference to FIG. 2, first position sensor component 218 uses a mechanical coupling (not shown) from actuator stem 216 to second position sensor component 226 to sense the position. In an embodiment, a magnet (not shown) is attached to actuator stem 216 or stem coupling that moves next to one or more devices detecting the position of actuator stem 216. Alternatively, any mechanism that measures the position of an actuator stem 216 through its range of travel that enables operation of valve assembly 200 may be used. Additionally, when valve assembly 200 is in the open position the spring range force is referred to as the high spring range force and when valve assembly 200 is in the closed position the spring range force is referred to as the low spring range force.

Classifying a data point as an up data point type, a down data point type, and a null data point type involves receiving a first data point. The first data point is classified as a null data point type as a reference in comparison to a second data point. The first data point is associated with a first position of actuator stem 216. The second data point is associated with a second position of actuator stem 216. The first position of first data point is compared to the second position of the second data point. Based on the comparison between the first position and the second position of actuator stem 216, the second data point is classified as an up data point type, a down data point type, or a null data point type.

If a second position of actuator stem 216 is greater than the first position of actuator stem 216 then the second data point is classified as an up data point type. The phrase “greater than” in this context refers to the second position of actuator stem 216 having, for instance, plug 236 closer to top portion 202 of valve assembly 200 than the first position of actuator stem 216.

In some embodiments, only data points associated with a certain threshold of a change in position of actuator stem 216 are classified as up data point types or down data point types. A threshold may be determined in relation to a percentage of a full range of motion of actuator stem 216. For example, actuator stem 216 may be in a fully closed position and referred to as being at a 0.00% position, and actuator stem 216 may be in a fully open position and referred to as being at a 100.00% position. In some embodiments utilizing the percentage of the full range of motion, if the second position of actuator stem 216 is greater than the first position of actuator stem 216 by a threshold percentage, then the second data point is classified as an up data point type. However, if the second position of the actuator stem 216 is greater than the first position of actuator stem 216, but not by the threshold percentage, then the second data point is not classified as an up data point type and may be classified as a null data point type. The threshold percentage may be, but is not limited to, 0.01% or 0.05%. Additionally, in some embodiments, a data point is only classified as an up data point type or a down data point type if the position of actuator stem 216 is in a certain range. The range may be, but is not limited to, between 2% and 98% or 20% and 80%. Further, in some embodiments, a data point that is located out of range, such as between 0% and 10% or 90% and 100%, is classified as a null data point type.

In some embodiments, a data point located out of specified range is classified as null because the data point is not be helpful in determining valve assembly characteristics as the data point is at an extreme operating point of actuator stem 216. In some embodiments, the data point may be classified as null data point type if setpoint is not between a certain percentage range, if position is not between a certain percentage range, or if the actuator pressure is not between certain PSI ranges. For example, a data point may be classified as null data point type if setpoint is not between 5% and 95%, or actuator pressure is not between 5 and 25 PSI. These conditions indicate that the data point is an outlier or actuator stem 216 is at an extreme operating point or is at an operating point that is not of concern for determining valve assembly characteristics. A data point is classified as null data point type if the data point is not useful or warranted for determining valve assembly characteristics. For example, if valve assembly characteristics are being determined for a certain position of actuator stem 216, for instance between 50% and 70%, then data points associated with actuator stem between 0%-50% and 70% and 100% would be classified as null data point types.

If the second position of actuator stem 216 is less than the first position of actuator stem 216 then the second data point is classified as a down data point type. The phrase “less than” in the this context refers to the second position of actuator stem 216 having, for instance, plug 236 closer to bottom portion 201 of valve assembly 200 than the first position of actuator stem 216. If the second position of actuator stem 216 is equal to the first position of actuator stem 216, then the second data point is classified as a null data point type. In some embodiments, only data points associated with a certain threshold of a change in position of actuator stem 216 are classified as up data point types or down data point types, as described above. In some embodiments utilizing the percentage of the full range of motion, if the second position of actuator stem 216 is lesser than the first position of actuator stem 216 by a threshold percentage, then the second data point is classified as a down data point type.

An example of classifying a data point is provided in relation to a first data point 372 (shown in FIG. 3) and a second data point 374 (shown in FIG. 3). In some aspects, first data point 372 is received and automatically classified as a null data point type. First data point 372 is associated with a first position of actuator stem 216. Second data point 374 is received and is associated with a second position of actuator stem 216. Second data point 374 is compared to first data point 372.

A data point originally classified as a first type of data point may be reclassified as a second type of data point based on a classification of a second data point. For instance, if a first data point is classified as a down data point and a second data point is classified as an up data point based on a comparison between the two data points, then the first data point may be reclassified as a null data point type. Similarly, if a first data point is classified as an up data point type and a second data point is classified as a down data point type, then the first data point may be reclassified as a null data point type.

There are many forces involved in the actuation that occurs within valve assembly 200. The forces involved include, but are not limited to, the force of actuator 210 and spring 214, and the friction between actuator stem 216 and packing 234. Other forces that may act on actuator stem 216 include the flow of the process fluid and friction from other sources.

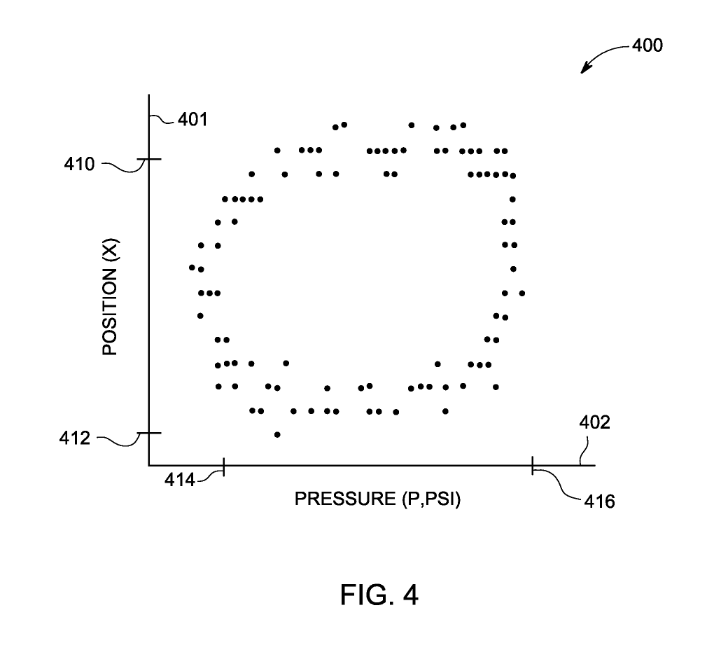

FIGS. 4 is a graphical view 400 of exemplary data points related to a position of valve assembly 200 (shown in FIG. 2) and an actuator pressure associated with actuator stem 216 (shown in FIG. 2). Graph 400 has a y-axis 401 and an x-axis 402. Y-axis 401 represents a position of actuator stem 216. Along y-axis 401 are a first reference y-axis value 410 and a second reference y-axis value 412. The distance between first reference y-axis value 410 and second reference y-axis value 412 represents a distance actuator stem 216 has traveled within a specific period of time. For example, the distance may be equal to the full range of motion of actuator stem 216. In another example, the distance may be equal to a portion of the full range of motion of actuator stem 216. X-axis 402 represents actuator pressure in PSI associated with valve assembly 200. Along x-axis are a third reference x-axis value 414 and a fourth reference x-axis value 416. Third reference x-axis value 414 is indicative of a lower spring range force while fourth reference x-axis value 416 is indicative of a higher spring range force. The actuator pressure may increase incrementally along the x-axis 402 from third reference x-axis value 414 to fourth reference x-axis value 416. FIG. 4 illustrates data points that are not classified according to the direction of travel of actuator stem 216.

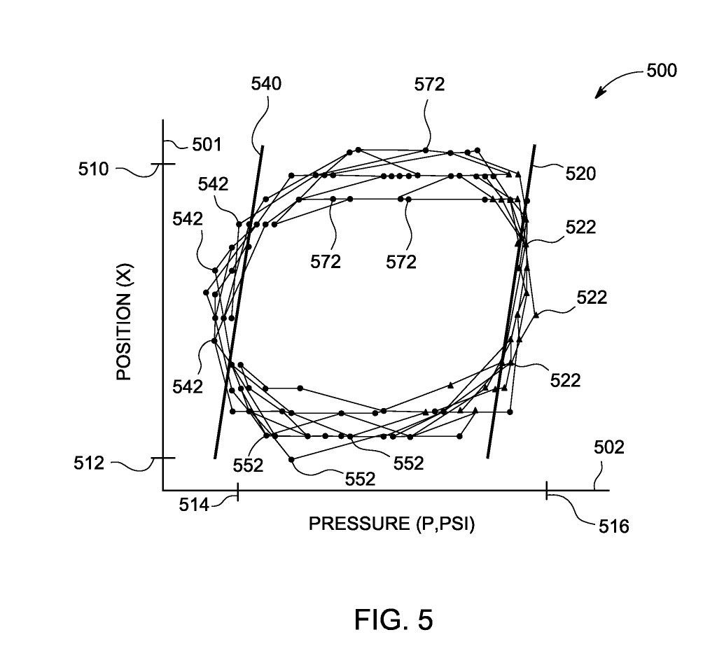

FIG. 5 is a graphical view 500 of the data points (shown in FIG. 4) as classified according to the present disclosure. Graph 500 has a y-axis 501 and an x-axis 502. Y-axis 501 represents a position of actuator stem 216 (shown in FIG. 2). Along y-axis 501 are a first reference y-axis value 510 and a second reference y-axis value 512. The distance between first reference y-axis value 510 and second reference y-axis value 512 represents a distance actuator stem 216 has traveled within a specific period of time. For example, the distance may be equal to the full range of motion of actuator stem 216. In another example, the distance may be equal to a portion of the full range of motion of actuator stem 216. X-axis 502 represents actuator pressure in PSI associated with valve assembly 200. Along x-axis are a third reference x-axis value 414 and a fourth reference x-axis value 516. Third reference x-axis value 514 is indicative of a lower spring range force while fourth reference x-axis value 516 is indicative of a higher spring range force. The actuator pressure may increase incrementally along x-axis 502 from third reference x-axis value 514 to fourth reference x-axis value 516. A first characteristic line 520 illustrates the relationship between the position of actuator stem 216 and the actuator pressure as actuator stem 216 travels in an upward direction. A second characteristic line 540 illustrates the relationship between the position of actuator stem 216 and the actuator pressure as actuator stem 216 travels in a downward direction. Graph 500 illustrates data points being classified according to a direction of travel of actuator stem 216. Data points 522 are illustrated as having arrows facing a first direction indicating a first direction of travel of actuator stem 216. Data points 542 are illustrated as having arrows facing a second direction indicating a second direction of travel of actuator stem 216. Data points 552 and 572 are shaped differently from both data points 522 and 542 and refer to a change in direction of actuator stem 216.

Utilizing a classification of data points as up data point types, down data point types, or null data point types, valve assembly characteristics, such as friction, low spring range, and high spring range can be determined through the solving of the linear equations described below.

Referring to FIG. 2, a force balance relationship between diaphragm 212, spring 214 and friction is provided below in equation 1, as follows:

0=S−P−D*F, Eq. (1)

where S is the spring force, P is the diaphragm force, D is the direction of travel of actuator stem 216, and F is the frictional force between actuator stem 216 and packing 234. D is 1 when actuator stem 216 is moving in the upwards direction of travel. D is (−1) when actuator stem 216 is moving in the downwards direction of travel.

As indicated above, the spring force of valve assembly 200 is typically characterized in the following manner. When valve assembly 200 is fully closed, the force of spring 214 is referred to as the low spring range force (SL). When valve assembly 200 is fully open, the force of spring 214 is referred to as the high spring range force (SH). A position of actuator stem 216 is denoted as X. When actuator stem 216 is in the fully closed position X equal 0 and when actuator stem 216 is in the fully open position X equals 1. The spring force at a given position of X is then modeled as equation 2 as follows:

S=SL*(1−X)+SH*X. Eq. (2)

By substituting the spring force of equation 2 into equation 1, the force balance relationship of equation 3 is provided as follows:

0=SL*(1−X)+SH*X−P−D*F. Eq. (3)

The position data is processed and each data point is classified an up data point type, a down data point type, or a null data point type. The data points classified as null data point types are not used in determining the characteristics of valve assembly 200.

After classifying data points according to the direction of travel of actuator stem 216, equation 3 becomes a linear equation with an indication of the direction of travel. In instances where the data point taken as an index (i) and is classified as an up data point type, the force balance relationship is represented as:

0=SL*(1−X[i])+SH*(X[i])−P[i]−F, Eq. (4)

where the index (i) is a data sample index. The data sample index varies from 1 to N where N is the number of data samples being used, i.e. the number of data samples where the classification is up or down. Each data sample being used consists of a single actuator pressure value P(i) and a single position value X(i). In some embodiments, the total number of data samples being used (N) will be less than the total number collected because some data samples will be classified as a null data point type will be excluded.

Equation 4 may be expressed in linear form as:

(P[i])=(1−X[i])*SL+(X[i])*SH+(−1)*F. Eq. (5)

In instances where the data point taken as an index i and is classified as a down data point type, the force balance relationship is represented as:

0=SL*(1−X[i]+SH*(X[i])−P[i]−F. Eq. (6)

Equation 6 may be expressed in linear form as:

(P[i])=(1−X[i])*SL+(X[i])*SH+(1)*F. Eq. (7)

By segmenting data into up data point types and down data point type a linear set of equations is provided with three unknowns of friction, low spring range force, and high spring range force. Additionally, the number of equations is the sum of the number of points that are classified an up data point types and down data point types. In some aspects, there will be many more equations than unknowns or at least three equations.

Several existing and commonly used methods of solving linear equations may be used to determine friction, low spring range, and high spring range provided in the equations above. It is possible to find the least squares solution for friction, low spring range, and high spring range where the root mean square error of the actuator pressure residual is minimized. Additionally, it is possible to find the least absolute value solution for friction, low spring range, and high spring range where the mean absolute error of the actuator pressure residual is minimized. The least absolute value solution may be desirable in some instances because the mean absolute error cost function makes the system more robust to outlier data samples. In addition to the least squares solution or the least absolute value solution there are many other suitable linear system solvers. Many of these solvers allow one to provide a weighting factor to each data point or each equation. For example, the weighting factor is derived from an estimate of the noise in the raw data measurement values or from the confidence that the data point corresponds to an upwards direction of travel or a downwards direction of travel of actuator stem 216.

Linear system solvers are used to produce confidence intervals of the estimates of friction, low spring range, and high spring range may be produced. Linear system solvers produce a variance or confidence interval on estimates of parameters friction, low spring range, and high spring range. The accuracy with which these values are determined by this method depends to some degree on the actions of valve assembly 200 (shown in FIG. 2) during data capture. For example, if actuator stem 216 (shown in FIG. 2) moves up and down a large distance the estimates will be more accurate and the confidence intervals smaller. At the other extreme, if actuator stem 216 moves only in one direction, or does not move at all, then the linear set of equations will have no solution and the linear system solver will produce no value for friction, low spring range, and high spring range. In between, with varying amounts of up and down motion of actuator stem 216 as the sample data is collected, the accuracy of the estimates of friction, low spring range, and high spring range will vary. When the accuracy is high the confidence intervals will be narrow, and when the accuracy is low the confidence intervals will be wider apart. Repeated data collection and determination of friction will result in a series of estimates with different confidence intervals. These confidence intervals may be used in trend plots of friction over time the display accuracy or to eliminate and not display inaccurate estimates. Further, goodness-of-fit metrics produced by the linear system solver can be used to assess the accuracy and usability of the estimate of friction and spring range.

In some instances, it is possible have the spring range for valve assembly 200, but not the friction. In such instances, the low spring range and the high spring range are known, but friction is not. The method still applies in this case, and can be used to estimate the friction. A linear equation similar to the linear equation 4 can be used, but with a new form for up points:

(P[i])−(1−X[i])*SL−(X[i])*SH=(−1)*F. Eq. (8)

Additionally, a linear equation similar to the linear equation 6 can be used, but with a new form for down points:

(P[i])−(1−X[i])*SL−(X[i])*SH=(1)*F. Eq. (9)

The equations now have a single unknown, friction (F). The estimation of friction with a known spring range is especially useful in some aspects because the spring range of a valve assembly is much less likely to change over time than the friction.

There is an exemplary two-stage strategy to utilize instances where the spring range of valve assembly 200 (shown in FIG. 2) is less likely to change over time than the friction. Data points may be collected from a valve assembly over a long period of time, even weeks or months. In stage 1, friction and spring range of valve assembly 200 using data collected over a long period of time is estimated. The use of a large amount of data, where valve assembly 200 potentially goes through a large amount of travel, will give an accurate estimate of spring range. The friction estimate from this stage may be discarded. In stage 2, the spring range from stage 1 is taken as a known spring range, and the directionally applicable algorithm presented in equation 8 or equation 9 is applied to shorter segments of data, where the friction is assumed to be stable or nearly constant. This will result in a more accurate short-term estimate of friction. The two stage approach may be applied in a rolling manner, i.e., subsequently after one another and repeatedly. Any time it is necessary to estimate friction, the stage 1 process can be applied to a large amount of historical data to determine the spring range, and the stage 2 process can be applied to more recent data to determine friction.

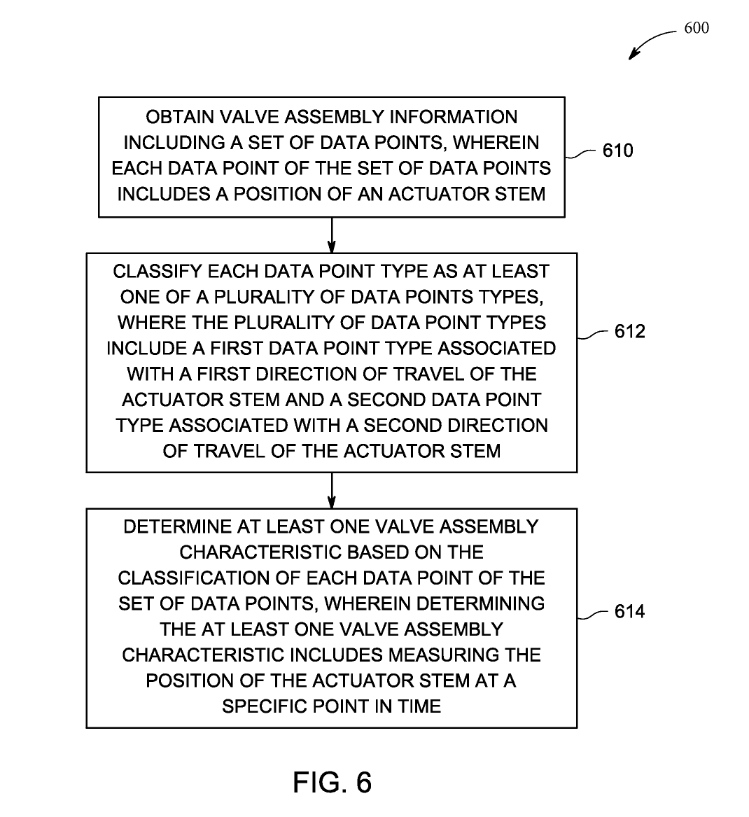

FIG. 6 is a flow chart of an exemplary method 600 for performing diagnostics for valve assembly 200 (shown in FIG. 2). Valve assembly information is obtained 610. Valve assembly information includes a set of data points where each data point of the set of data points includes a position of actuator stem 216 (shown in FIG. 2). Each data point of the set of data points is classified 620 as at least one of a plurality of data point types where the plurality of data point types include a first data point type and a second data point type. The first data point type is associated with a first direction of travel of actuator stem 216. The second data point type is associated with a second direction of travel of actuator stem 216. At least one valve assembly characteristic is determined 616 based on the classification of each data point of the set of data points, where determining the at least one valve assembly characteristic includes measuring the position of actuator stem 216 at a specific point in time.

In the exemplary embodiment, system 270 includes positioner 220 and diagnostic component 272 (all shown in FIG. 2). In some embodiments, diagnostic component 272 is configured to receive the plurality of setpoints for positioning actuator stem 216 (shown in FIG. 2), obtain valve assembly information including a set of data points, where each data point of the set of data points is associated with a position of actuator stem 216. Diagnostic component 272 is also configured to classify each data point of the set of data points as at least one of a plurality of data point types, where the plurality of data point types includes a first data point type associated with a first direction of travel of the actuator stem and a second data point type associated with a second direction of travel of the actuator stem. Additionally, diagnostic component 272 is configured to determine at least one valve assembly characteristic based on the classification of each data point of the set of data points, where diagnostic component 272 is further configured to measure the position of actuator stem 216 at a specific point in time.

In other embodiments, system 270 includes positioner 220 without diagnostic component 272. In some embodiments, positioner 220 is configured to receive the plurality of setpoints for positioning actuator stem 216, obtain valve assembly information including a set of data points, where each data point of the set of data points is associated with a position of actuator stem 216. Positioner 220 is also configured to classify each data point of the set of data points as at least one of a plurality of data point types, where the plurality of data point types includes a first data point type associated with a first direction of travel of actuator stem 216 and a second data point type associated with a second direction of travel of actuator stem 216. Additionally, positioner 220 is configured to determine at least one valve assembly characteristic based on the classification of each data point of the set of data points, where positioner 220 is further configured to measure the position of actuator stem 216 at a specific point in time.

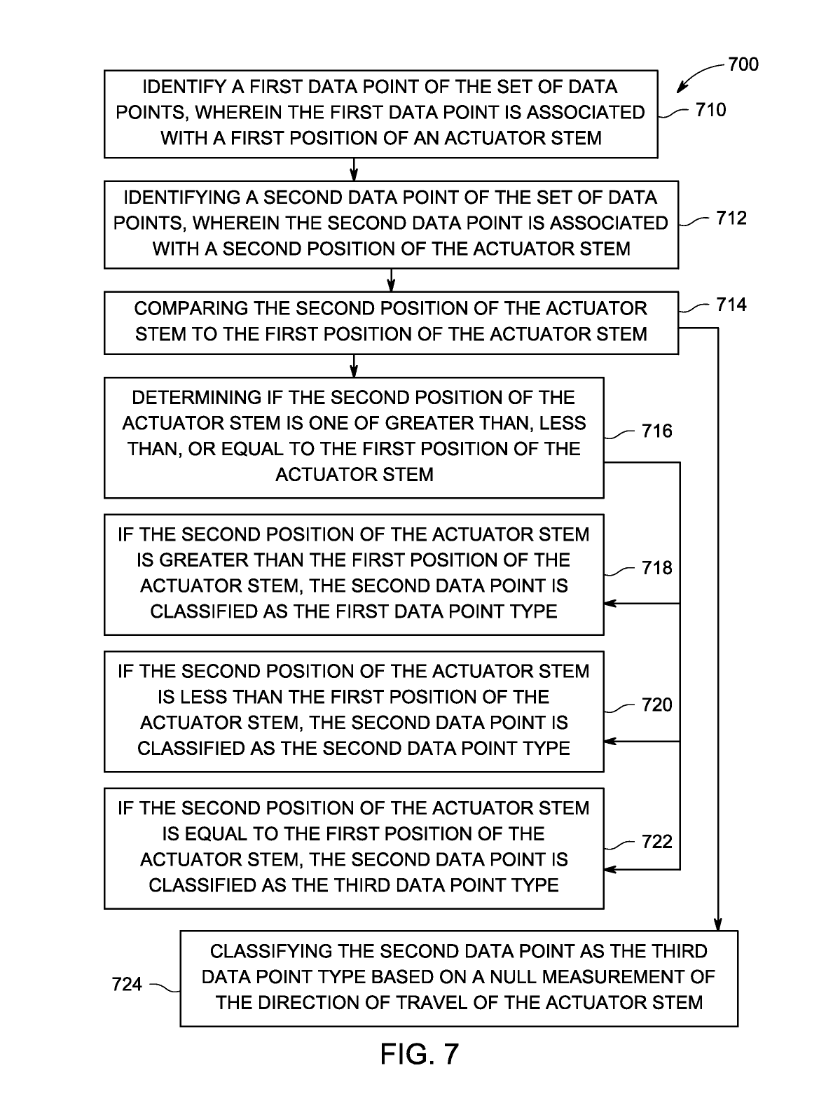

FIG. 7 is a flow chart of an exemplary method 700 for classifying a data point associated with valve assembly 200 (shown in FIG. 2). A first data point of the set of data points is identified 710 where the first data point is associated with a first position of actuator stem 216 (shown in FIG. 2). A second data point of the set of data points is identified 712 where the second data point is associated with a second position of actuator stem 216. The second position of actuator stem 216 is compared to the first position of actuator stem 216. A determination 714 of whether or not the second position of actuator stem 216 is greater than, less than, or equal to the first position of actuator stem 216 is made. If the second position of actuator stem 216 is greater than the first position of actuator stem 216, then the second data point is classified 718 as a first data point type. The first data point type may be an up data point type. If the second position of actuator stem 216 is less than the first position of actuator stem 216, then the second data point is classified 720 as a second data point type. The second data point type may be a down data point type. If the second position of actuator stem 216 is equal to the first position of actuator stem 216, then the second data point is classified 722 as a third data point type. The third data point type may be a null data point type. In the alternative of determination 714, the second data point type is classified 724 as the third data point type based on an erroneous measurement of the direction of travel of actuator stem 216. The third data point type may be a null data point type.

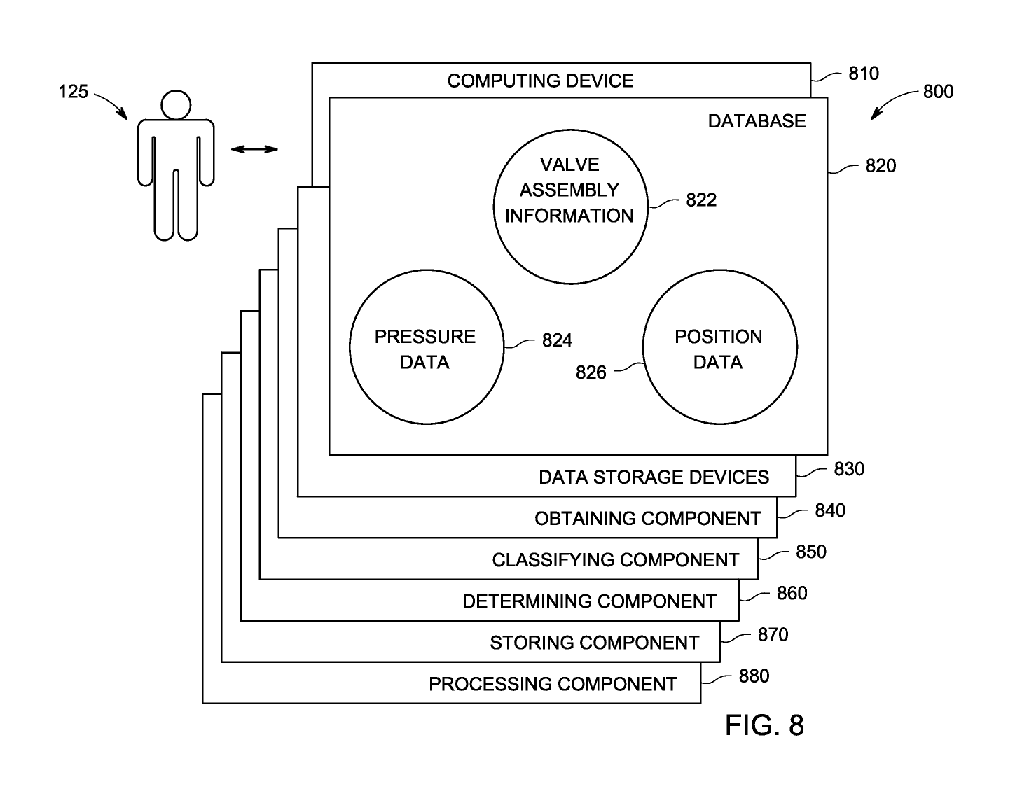

FIG. 8 illustrates an example configuration 800 of a database 820 within a computing device 810, along with other related computing components, that may be used during analysis and operations on the data streams as described herein. Database 820 is coupled to several separate components within computing device 810, which perform specific tasks. In the exemplary embodiment, computing device 810 is computing device 105 (shown in FIG. 1).

In the exemplary embodiment, database 820 includes valve assembly information 822, actuator pressure data 824, and actuator stem position data 826. Valve assembly information 822 includes a set of data points associated with valve assembly 200 (shown in FIG. 2). Actuator pressure data 824 includes information associated with pressure measurement at specific time. Position data 826 includes an indication of the position of actuator stem 216 (shown in FIG. 2) at a specific time, direction of travel of actuator stem 216 at a specific time, and speed of actuator stem 216 at a specific time.

Computing device 810 includes database 820, as well as data storage devices 80. Computing device 810 also includes an obtaining component 840 for obtaining valve assembly information 822. Computing device 810 further includes a classifying component 850 for classifying each data point of the set of data points included in valve assembly information 822. A determining component 860 is also included for determining at least one valve assembly characteristic based on the classification of each data point of the set of data points and the data points themselves. Moreover, computing device 810 includes a storing component 870 for storing the classification of each data point of the set of data points. A processing component 880 assists with execution of computer-executable instructions associated with processor 115 (shown in FIG. 1).

The above described methods, systems, and computer-readable media relate to performing diagnostics for a valve assembly. The embodiments described herein include obtaining data associated with the actuation of an actuator stem while a valve assembly is online and operating. Data points taken while the valve assembly is operating are classified according to a direction of travel of the actuator stem at the time each data point is taken. For instance, a data point collected when the actuator is traveling in an upwards direction would be classified as an up data point whereas a data point collected when the actuator stem is traveling in a downwards direction would be classified as a down data point type. By classifying the data points according to the direction of travel of the actuator stem, a more accurate determination of valve assembly characteristics, such as frictional force, low spring range force, and high spring range force, is provided.

An exemplary technical effect of the methods, systems, computer-readable media described herein includes at least one of: (a) remotely obtaining valve assembly information including a set of data points that each include position of an actuator stem while the valve assembly is in service; (b) classifying each data point of the set of data points as at least one of a first data point type associated with a first direction of travel of the actuator stem and a second data point type associated with a second direction of travel of the actuator stem, thereby remotely determining and recording the direction of travel of the actuator stem while the valve is in service; and (c) determining at least one of a frictional force, a low spring range, and a high spring range based on the direction of travel of the actuator stem as indicated by the classification of each data point.

Exemplary embodiments of methods, systems, and computer-readable media for performing diagnostics for a valve assembly are not limited to the specific embodiments described herein, but rather, components of systems and/or steps of the methods may be utilized independently and separately from other components and/or steps described herein. Rather, the exemplary embodiment can be implemented and utilized in connection with many other applications, equipment, and systems that may benefit from performing diagnostics for a valve assembly.

Although specific features of various embodiments of the disclosure may be shown in some drawings and not in others, this is for convenience only. In accordance with the principles of the disclosure, any feature of a drawing may be referenced and/or claimed in combination with any feature of any other drawing.

Some embodiments involve the use of one or more electronic or computing devices. Such devices typically include a processor or controller, such as a general purpose central processing unit (CPU), a graphics processing unit (GPU), a microcontroller, a reduced instruction set computer (RISC) processor, an application specific integrated circuit (ASIC), a programmable logic circuit (PLC), and/or any other circuit or processor capable of executing the functions described herein. The methods described herein may be encoded as executable instructions embodied in a computer readable medium, including, without limitation, a storage device and/or a memory device. Such instructions, when executed by a processor, cause the processor to perform at least a portion of the methods described herein. The above examples are exemplary only, and thus are not intended to limit in any way the definition and/or meaning of the term processor.

This written description uses examples to disclose the embodiments, including the best mode, and also to enable any person skilled in the art to practice the embodiments, including making and using any devices or systems and performing any incorporated methods. The patentable scope of the disclosure is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. A method for performing diagnostics for a valve assembly, the valve assembly including a valve and an actuator, the actuator including an actuator stem, said method comprising:
obtaining valve assembly information including a set of data points, wherein each data point of the set of data points includes a position of the actuator stem;
classifying each data point of the set of data points as at least one of a plurality of data point types, wherein the plurality of data point types comprises a first data point type associated with a first direction of travel of the actuator stem and a second data point type associated with a second direction of travel of the actuator stem; and
determining at least one valve assembly characteristic based on the classification of each data point of the set of data points, wherein determining the at least one valve assembly characteristic includes measuring the position of the actuator stem at a specific point in time.

2. The method of claim 1, wherein the plurality of data point types further comprises a third data point type associated with at least one of a change in direction of travel of the actuator stem and an erroneous measurement of the direction of travel of the actuator stem.

3. The method of claim 1, further comprising obtaining valve assembly information while the valve assembly is placed in service.

4. The method of claim 1, wherein the at least one valve assembly characteristic includes at least one of friction, a low spring range, and a high spring range.

5. The method of claim 1, wherein determining the at least one valve assembly characteristic comprises solving a set of linear equations.

6. The method of claim 5, wherein the set of linear equations model a force balance relationship in the valve assembly that includes the effect of at least one of springs, friction, actuator pressure, and the position of the actuator stem.

7. The method of claim 6, wherein a number of the linear equations within the set of linear equations is equal to a sum of data points classified as the first data point type and data points classified as the second data point type.

8. The method of claim 2, wherein classifying each data point comprises processing the position of the actuator stem over time.

9. The method of claim 8, wherein classifying each data point further comprises:
identifying a first data point of the set of data points, wherein the first data point is associated with a first position of the actuator stem;
identifying a second data point of the set of data points, wherein the second data point is associated with a second position of the actuator stem; and
comparing the second position of the actuator stem to the first position of the actuator stem.

10. The method of claim 9, further comprising determining if the second position of the actuator stem is one of greater than, less than, or equal to the first position of the actuator stem, wherein:
if the second position of the actuator stem is greater than the first position of the actuator stem, the second data point is classified as the first data point type;
if the second position of the actuator stem is less than the first position of the actuator stem, the second data point is classified as the second data point type; and
if the second position of the actuator stem is equal to the first position of the actuator stem, the second data point is classified as the third data point type.

11. The method of claim 10, further comprising classifying the second data point as the third point type based on an erroneous measurement of the direction of travel of the actuator stem.

12. The method of claim 8, wherein classifying each data point further comprises:
identifying a first data point of the set of data points, wherein the first data point is associated with a first position of the actuator stem;
classifying the first data point as the second data point type;
identifying a second data point of the set of data points, wherein the second data point is associated with a second position of the actuator stem; and
comparing the second position of the actuator stem to the first position of the actuator stem.

13. The method of claim 12, further comprising determining that the second position of the actuator stem is greater than the first position of the actuator stem and classifying the second data point as the first data point type.

14. The method of claim 13, further comprising reclassifying the first data point as the third data point type based on the classification of the second data point as the first data point type.

15. The method of claim 8, wherein classifying each data point comprises:
identifying a first data point of the set of data points, wherein the first data point is associated with a first position of the actuator stem;
classifying the first data point as the first data point type;
identifying a second data point of the set of data points, wherein the second data point is associated with a second position of the actuator stem; and
comparing the second position of the actuator stem to the first position of the actuator stem.

16. The method of claim 15, further comprising:
determining that the second position of the actuator stem is less than the first position of the actuator stem; and
classifying the second data point as the second data point type based on the determination that the second position of the actuator stem is less than the first position of the actuator stem.

17. The method of claim 16, further comprising reclassifying the first data point as the third data point type based on the classification of the second data point as the second data point type.

18. A system for determining characteristics of a valve assembly, the valve assembly including a valve and an actuator, the actuator including an actuator stem, said system comprising:
a positioner configured to receive a plurality of setpoints and generate a signal for positioning the actuator stem for each setpoint of the plurality of setpoints; and
at least one diagnostic component coupled to said positioner, said at least one diagnostic component configured to:
receive the plurality of setpoints for positioning the actuator stem;
obtain valve assembly information including a set of data points,
wherein each data point of the set of data points is associated with a position of the actuator stem;
classify each data point of the set of data points as at least one of a plurality of data point types, wherein the plurality of data point types comprises a first data point type associated with a first direction of travel of the actuator stem and a second data point type associated with a second direction of travel of the actuator stem; and
determine at least one valve assembly characteristic based on the classification of each data point of the set of data points, wherein said diagnostic component is configured to measure the position of the actuator stem at a specific point in time.

19. The system of claim 18, wherein said at least one diagnostic component is further configured to classify each data point of the set of data points as at least one of a third data point type associated with at least one of a change in direction of travel of the actuator stem and an erroneous measurement of the direction of travel of the actuator stem.

20. The system of claim 18, wherein the at least one valve assembly characteristic includes at least one of friction, a low spring range, and a high spring range.

21. The system of claim 18, wherein said diagnostic component is configured to solve a set of linear equations associated with the set of data points.

22. Computer-readable storage media for performing diagnostics for a valve assembly, the valve assembly including a valve and an actuator, the actuator including an actuator stem, the computer-readable storage media having computer-executable instructions embodied thereon, wherein, when executed by at least one processor, the computer-executable instructions cause the processor to:
obtain valve assembly information including a set of data points, wherein each data point of the set of data points is associated with a position of the actuator stem;
classify each data point of the set of data points as at least one of a plurality of data point types, wherein the plurality of data point types comprises a first data point type associated with a first direction of travel of the actuator stem and a second data point type associated with a second direction of travel of the actuator stem; and
determine at least one valve assembly characteristic based on the classification of each data point of the set of data points, wherein determining the at least one valve assembly characteristic includes measuring the position of the actuator stem at a specific point in time.

23. The computer-readable storage media of claim 22, wherein the computer-executable instructions cause the processor to classify a third data point type associated with at least one of a change in direction of travel of the actuator stem and an erroneous measurement of the direction of travel of the actuator stem.
